(19) United States
(12) Patent Application Publication
(10) Pub. No.: US 2026/0275040 A1
(43) Pub. Date: Sep. 17, 2026

(54) MULTIFUNCTIONAL HETEROLEPTIC POLYHEDRAL OLIGOMERIC SILSESQUIOXANE (POSS) AND FABRICATION METHODS THEREOF

(71) Applicant: Nano and Advanced Materials Institute Limited, Hong Kong (HK)

(72) Inventors: Yong ZHU, Hong Kong (HK); Yubo CHENG, Hong Kong (HK); Koonyee LIN, Hong Kong (HK); Fei ZHANG, Hong Kong (HK); Chun Lung CHOI, Hong Kong (HK); Li FU, Hong Kong (HK); Chenmin LIU, Hong Kong (HK)

(21) Appl. No.: 19/079,387

(22) Filed: Mar. 13, 2025

(51) Int. Cl. C08G 77/04; C08G 77/06

(52) U.S. Cl. CPC C08G 77/045; C08G 77/06

(57) ABSTRACT

A method for fabricating multifunctional heteroleptic polyhedral oligomeric silsesquioxane (POSS) in a single reaction vessel is introduced. The method involves creating an alkaline environment by adding a first organic solvent, water, and a base, followed by the dropwise introduction of organosilanes at a controlled rate of 0.1-0.5 g per second to prevent rapid gelation. The organosilanes, constituting 15-50% of the solution, undergo hydrolysis and condensation reactions at a defined temperature and duration, converting alkoxy groups to silanol groups and forming siloxane bonds, resulting in POSS cage structures. The reaction mixture is then adjusted to a pH of 3-5 by adding acid to quench condensation, stabilize the POSS, and prevent aggregation, yielding a POSS crude product.

### FIELD OF THE INVENTION

The present invention generally relates to the materials chemistry and nanotechnology field. More specifically the present invention relates to the synthesis and functionalization of polyhedral oligomeric silsesquioxane (POSS) materials.

### BACKGROUND OF THE INVENTION

Polyhedral oligomeric silsesquioxane (POSS) materials have emerged as a research focus due to their hybrid organic-inorganic structure, consisting of a silicon-oxygen cage framework with functional organic groups attached to the surface. This unique architecture allows POSS to enhance the thermal, mechanical, and chemical properties of various materials, offering exceptional thermal stability, mechanical strength, and chemical resistance. These attributes make POSS a valuable additive in coatings, adhesives, nanocomposites, and biomedical applications. Despite their promise, the synthesis of multifunctional POSS derivatives with precise functional group distributions remains a significant challenge.

Traditional methods for multifunctional POSS synthesis, such as the corner-capping technique, involve multi-step processes requiring silanol-functionalized intermediates to react with organosilanes. While effective, these methods are labor-intensive, yield low product quantities, and often struggle to control the distribution of functional groups, limiting their scalability and industrial utility. Similarly, hydrolytic condensation of organosilanes under acidic or basic conditions simplifies synthesis but lacks precise control over functional group distribution. Harsh reaction conditions and the use of organic solvents in these methods often lead to undesirable side reactions, low product purity, and environmental concerns, especially when synthesizing multifunctional POSS derivatives.

To address these issues, researchers have explored single-step or single-vessel synthesis processes that integrate hydrolysis and condensation of different functional silanes into a streamlined reaction system. These methods aim to reduce reaction time, minimize waste, and improve product yields. However, achieving precise control over the incorporation and distribution of multiple functional groups in a scalable process remains a technical hurdle. Current single-step approaches often result in incomplete cage formation or byproducts, limiting their application in advanced material systems.

One critical need lies in developing POSS materials that balance hydrophilic and hydrophobic properties. Hydrophilic derivatives are essential for compatibility with aqueous systems, making them suitable for waterborne coatings, adhesives, and biomedical applications. Conversely, hydrophobic derivatives enhance chemical resistance, moisture barrier properties, and compatibility with non-polar matrices, ideal for solvent-based systems. Multifunctional POSS materials that incorporate both hydrophilic and hydrophobic groups could bridge the gap between aqueous and organic phases, enabling their use in hybrid systems. However, existing methods struggle to achieve this balance without compromising product purity or structural integrity.

The integration of reactive functional groups, such as glycidyl, epoxy, or photo/thermal-curable moieties, further broadens the applicability of POSS materials. These groups enable POSS to participate in crosslinking or curing reactions, significantly improving the thermal stability, mechanical strength, and durability of the resulting materials. However, current synthesis techniques often lack the precision required to control their incorporation, resulting in inconsistent performance and limiting their potential in advanced applications.

Previous efforts to address these challenges include patented methodologies. For example, WO01/10871A1 describes selective manipulation of POSS molecules through macromolecular siloxane intermediates, while US20180282485A1 outlines the synthesis of POSS with epoxy-containing groups for enhanced curability and stability. WO2021183651A1 discloses a method for synthesizing multifunctional POSS via the reaction of organosilanes, water, and base in a solvent. However, these approaches suffer from limitations such as uncontrolled reaction rates, gel formation, and inconsistent functional group distribution, especially in heteroleptic POSS synthesis.

While POSS materials offer immense potential across various applications, existing synthesis methods are constrained by inefficiencies, environmental concerns, and lack of precision. There is a pressing need for an innovative synthesis method that streamlines the process, enhances scalability, and ensures high purity and tailored properties. Therefore, the present invention addresses these challenges by introducing a single-vessel synthesis process, enabling precise control over functional group incorporation, reduces reaction time, and minimizes environmental impact, paving the way for scalable production of advanced multifunctional POSS materials.

### SUMMARY OF THE INVENTION

It is an objective of the present invention to provide a compound, material, or method to solve the aforementioned technical problems.

In accordance with a first aspect of the present invention, a method of fabricating a multifunctional heteroleptic polyhedral oligomeric silsesquioxane (POSS) in a single reaction vessel is provided. Specifically, the method includes the following steps:
adding a first organic solvent, water, base in a reaction vessel to create an alkaline environment for hydrolysis and condensation reactions;
introducing a set of organosilanes in a dropwise manner at a controlled rate to prevent rapid gelation, wherein the total organosilane content accounts for 15-50% of the total solution, wherein the controlled rate is between 0.1-0.5 g per second to ensure uniform cage formation;
subjecting the reaction vessel to a defined temperature and duration to initiate hydrolysis and condensation reactions, wherein the hydrolysis reaction converts alkoxy groups of the organosilanes to silanol groups, and the condensation reaction condenses the silanol groups to form siloxane bonds, resulting in POSS cage structures; and
adjusting the reaction mixture to a pH value of 3-5 by adding an acid to quench the condensation reaction, stabilizing the POSS cage structures, and prevent POSS aggregation, thereby yielding a POSS crude product.

In accordance with one embodiment of the present invention, the set of organosilanes comprises glycidyltrimethoxysilane, cyclohexylepoxypropyltrimethoxysilane, methacryloxypropyltrimethoxysilane, acryloxypropyltrimethoxysilane, octyltrimethoxysilane, phenyltrimethoxysilane, aminopropyltrimethoxysilane, and polyethylene glycol (PEG)-modified silanes.

In accordance with one embodiment of the present invention, the alkaline environment has a pH value ranging from 12 to 14.

In accordance with one embodiment of the present invention, the defined temperate ranges from 25° C. to 150° C.

In accordance with one embodiment of the present invention, the reaction duration ranges from 2 to 24 hours.

In accordance with one embodiment of the present invention, the first organic solvent is selected from ethanol, acetone or a mixture thereof.

In accordance with one embodiment of the present invention, the method further includes adding phase transfer catalysts to facilitate interactions between hydrophilic and hydrophobic components.

In accordance with one embodiment of the present invention, the POSS crude product is further purified by:
removing the residual solvent and dissolving the crude POSS in a POSS-philic solvent;
using a siloxane gel-philic solvent to induce a liquid-liquid phase separation, thereby forming a siloxane gel phase and a POSS-philic solvent phase;
collecting, filtering, and evaporating the POSS-philic solvent phase to obtain a purified POSS product with a purity of over 98%.

In accordance with one embodiment of the present invention, the POSS-philic solvent is selected from relatively polar organic solvents, such as acetone, butanone, acetonitrile, ethanol, or methanol.

In accordance with one embodiment of the present invention, the siloxane gel-philic solvent is selected from toluene, n-hexane, or cyclohexane.

In accordance with a second aspect of the present invention, a multifunctional heteroleptic POSS produced by the aforementioned method is provided.

In accordance with one embodiment of the present invention, the multifunctional heteroleptic POSS comprises two reactive and thermal stable groups: glycidyl-containing R¹ and cyclohexylepoxy-containing R², a photo/thermal-curable crosslinking group R³, a hydrophobic group R⁴, and a hydrophilic group R⁵.

In accordance with one embodiment of the present invention, the multifunctional heteroleptic POSS has a formula: [R¹ₘR²ₙR³ₒR⁴ₚR⁵_{q}][SiO₃/₂]_{m+n+o+p+q}.

In accordance with one embodiment of the present invention, the R¹ is selected from one of more of epoxypropoxy, epoxidized olefins, glycidyl, and glycidyl ether; the R² is selected from one of more of epoxycyclohexane and cycloaliphatic epoxy; the R³ is selected from one or more of the following: amine, oxetane, episulfide, acrylate, methacrylate, thiol-acrylate, thiol-methacrylate, acrylamide, vinyl sulfide, vinyl ether, styrene, norbornyl, cyclopentadiene, and acryloxypropyl; the R⁴ is selected from alkyl chains, phenyl group, perfluoropolyether (PFPE), polytetrafluoroethylene (PTFE), and polydimethylsiloxane (PDMS); the R⁵ is selected from alkyl chains, phenyl group, perfluoropolyether (PFPE), polytetrafluoroethylene (PTFE), and polydimethylsiloxane (PDMS); and the m, n, o, p and q range from 0 to 20 with a sum equal or less than 20.

In accordance with one embodiment of the present invention, the multifunctional heteroleptic POSS is applied in advanced coatings, adhesives, biomedical materials, or nanocomposites.

### DETAILED DESCRIPTION

In the following description, compounds, materials, and/or methods of multifunctional heteroleptic POSS and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

POSS are nanoscale hybrid materials composed of a silica-like core with organic functional groups attached to the corners. Their general formula is (RSiO_{1.5})n, where R represents organic functional groups, and n is typically 6, 8, 10, or 12, forming cage-like structures. POSS combines the properties of both organic polymers and inorganic materials.

In accordance with a first aspect of the present invention, a method for fabricating multifunctional heteroleptic POSS within a single reaction vessel is provided. The method begins by creating an alkaline environment in the reaction vessel, achieved by introducing a combination of a first organic solvent, water, and a base. The alkaline conditions, maintained at a pH range of 12 to 14, are specifically designed to support hydrolysis and condensation reactions essential for POSS synthesis. This high-pH environment facilitates rapid and complete hydrolysis of silane precursors, minimizing side products and enhancing the yield of the desired POSS cage structures.

To ensure controlled reactions and prevent rapid gelation, a set of organosilanes is introduced into the reaction vessel dropwise at a controlled rate, typically between 0.1 and 0.5 grams per second. This controlled addition prevents high local concentrations of silanes, which could lead to uncontrolled reaction rates, gel formation, or self-condensation. The total amount of organosilanes is adjusted to account for 15-50% of the total solution, striking a balance between efficient cage formation and solution stability. The set of organosilanes includes glycidyltrimethoxysilane, cyclohexylepoxypropyltrimethoxysilane, methacryloxypropyltrimethoxysilane, acryloxypropyltrimethoxysilane, octyltrimethoxysilane, phenyltrimethoxysilane, aminopropyltrimethoxysilane, and polyethylene glycol (PEG)-modified silanes. These diverse functional groups enable the creation of POSS materials with tailored properties for advanced applications.

The reaction mixture is maintained at a defined temperature range of 25° C. to 150° C. and stirred continuously to ensure uniform mixing. Hydrolysis converts the alkoxy groups of the organosilanes into silanol groups, while condensation facilitates the formation of siloxane bonds, resulting in robust POSS cage structures. The reaction duration is adjusted between 2 and 24 hours, depending on the desired functionalization and polymerization. Optional additives, such as phase transfer catalysts (e.g., tetrabutylammonium bromide), may be included to enhance reaction kinetics and improve interactions between hydrophilic and hydrophobic components.

Upon completing the hydrolysis and condensation reactions, the mixture is neutralized by adding an acid, such as acetic acid or hydrochloric acid, to adjust the pH to a mildly acidic range of 3-5. This quenching step stabilizes the POSS cage structures, prevents aggregation, and halts further reactions.

This neutralization step is critical for achieving a uniform and well-defined POSS structure. Adding a suitable acid to quench the POSS cage formation process, forming a salt with the base added in earlier, which further prevents silanol formation from the hydrolysis of Si—O—Si bonds in the POSS cage. In some embodiments, the formed salt may be semi-soluble in the first organic solvent, water, and the raw multifunctional POSS mixture, and it can be removed in the later purification process.

The crude POSS product undergoes an optional purification process to enhance its purity. Residual solvents are first removed, and the crude POSS is dissolved in a POSS-philic solvent, such as acetone, butanone, acetonitrile, ethanol, or methanol. A siloxane gel-philic solvent, such as toluene, n-hexane, or cyclohexane, is introduced to induce liquid-liquid phase separation, isolating the siloxane gel phase from the POSS-philic solvent phase. The latter is collected, filtered, and evaporated to yield a purified POSS product with a purity exceeding 98%. The final product is dried under reduced pressure to achieve a uniform powder form.

This separation step effectively isolates the siloxane gel phase from the POSS-philic solvent phase. The POSS-philic solvent phase is subsequently collected, filtered, and evaporated to yield a purified POSS product with a purity exceeding 98%, as verified by spectroscopic and chromatographic methods.

This method eliminates the need for intermediate purification steps, significantly reducing reaction time and operational complexity. The integration of hydrolysis, condensation, and functionalization into a single reaction system enables precise control over the distribution and ratio of functional groups, allowing for the tailored design of POSS materials with specific properties. Additionally, the process minimizes the use of hazardous chemicals and solvents, reducing environmental impact and waste generation. It is scalable for industrial production, ensuring consistent quality and high yields, making it an ideal solution for manufacturing high-purity multifunctional POSS materials for applications in coatings, adhesives, nanocomposites, and biomedical systems.

In accordance with a second aspect of the present invention, a multifunctional heteroleptic POSS described in the present invention is produced using the aforementioned single-vessel synthesis method. This POSS structure features a combination of diverse functional groups that enable superior performance across various applications. By leveraging the controlled fabrication process, the resulting heteroleptic POSS materials exhibit precise functional group distribution, exceptional purity, and uniform molecular structure.

The multifunctional heteroleptic POSS is characterized by incorporating two reactive and thermally stable groups: glycidyl-containing groups (R¹) and cyclohexylepoxy-containing groups (R²). These groups contribute to enhanced chemical reactivity and thermal stability, essential for advanced material applications. Additionally, the POSS structure includes a photo/thermal-curable crosslinking group (R³), a hydrophobic group (R⁴), and a hydrophilic group (R⁵). This combination of functionalities enables the material to perform effectively in hybrid systems, bridging compatibility between aqueous and organic phases.

Structurally, the multifunctional heteroleptic POSS is represented by the formula [R¹ₘR²ₙR³ₒR⁴ₚR⁵_{q}][SiO₃/₂]_{m+n+o+p+q}, where each functional group is carefully selected to achieve tailored properties. Specifically:
R¹ includes glycidyl-based moieties such as epoxypropoxy, epoxidized olefins, glycidyl, and glycidyl ether, providing reactivity for polymer crosslinking and thermal curing.
R² consists of epoxycyclohexane and cycloaliphatic epoxy groups, which contribute to mechanical strength and chemical resistance.
R³ encompasses photo/thermal-curable crosslinking groups, including amine, oxetane, episulfide, acrylate, methacrylate, thiol-acrylate, thiol-methacrylate, acrylamide, vinyl sulfide, vinyl ether, styrene, norbornyl, cyclopentadiene, and acryloxypropyl, enabling robust network formation under controlled conditions.
R⁴ provides hydrophobic properties through alkyl chains, phenyl groups, perfluoropolyether (PFPE), polytetrafluoroethylene (PTFE), or polydimethylsiloxane (PDMS), enhancing moisture resistance and compatibility with nonpolar matrices.
R⁵ introduces hydrophilic functionalities using alkyl chains, phenyl groups, PFPE, PTFE, or PDMS, ensuring compatibility with aqueous systems and improved dispersibility.
The values of m, n, o, p, and q, representing the number of functional groups, range from 0 to 20, with the total sum being less than or equal to 20. This flexible compositional range ensures adaptability for diverse material requirements.

These multifunctional heteroleptic POSS structures are particularly suited for applications in advanced coatings, adhesives, biomedical materials, and nanocomposites. Their tailored functional groups enable properties such as enhanced mechanical strength, thermal stability, chemical resistance, and biocompatibility. For instance, in coatings and adhesives, the POSS material provides improved durability, resistance to environmental degradation, and superior adhesion performance. In biomedical materials, the hydrophilic and reactive groups enable compatibility with biological systems and allow for functionalization with bioactive molecules. In nanocomposites, the combination of hydrophobic and hydrophilic groups ensures uniform dispersion, leading to materials with superior mechanical and thermal properties.

The multifunctional heteroleptic POSS of the present invention represents a significant advancement in material science, addressing the challenges of precision, scalability, and functionality in high-performance applications.

### EXAMPLES

### Example 1. The Fabrication of a Multifunctional Heteroleptic POSS, [(Glycidoxypropyl)₈(Epoxycylohexylethyl)₂][SiO_{1.5}]₁₀

In a reactor, 5 g of water, 50 g of acetone, 60 g of tetrahydrofuran, and 0.5 g of lithium hydroxide (LiOH) are mixed thoroughly to create an alkaline reaction environment. The mixture is then heated to 60° C. for 10 minutes to ensure complete dissolution and homogenization. Subsequently, a silane mixture consisting of 8 g of epoxycyclohexylethyl trimethoxysilane and 25 g of 3-glycidoxypropyl trimethoxysilane is added dropwise to the reaction vessel at a controlled rate of 0.2 g per second. The dropwise addition is completed within 3 minutes, maintaining the pH of the reaction solution between 13 and 14.

The reaction conditions are maintained at 60° C. for 5 hours to allow hydrolysis and condensation reactions to proceed under the alkaline environment, facilitating the formation of POSS cage structures. Upon completion of the reaction, the mixture is cooled to room temperature. To remove impurities and unreacted components, the crude product is washed with saturated saline water and extracted using ethyl acetate. The upper organic layer is collected and dried over magnesium sulfate to remove residual moisture.

Next, the solvent in the dried organic solution is evaporated at 40° C. using a rotary evaporator, yielding the raw POSS product. To purify the raw POSS, ethanol is added to redissolve the material, and the solution is stirred for 1 hour. Toluene is then introduced to the ethanol solution to perform a liquid-liquid extraction. After the phase separation, the upper toluene layer is collected and subjected to drying, yielding the final product.

The resulting purified POSS product, identified as [(Glycidoxypropyl)₈(Epoxycylohexylethyl)₂][SiO_{1.5}]₁₀, is a clear, colorless liquid. The synthesis method demonstrates high efficiency, producing a well-defined POSS structure with precise functional group distribution suitable for advanced applications.

### Example 2. The Fabrication of a Multifunctional Heteroleptic POSS, [(Glycidoxypropyl)₄(Heptadecafluorodecyl)₂(PEG)₂][SiO_{1.5}]₈

A reaction mixture is prepared by combining 20 g of water, 120 g of dioxane, 20 g of trifluorotoluene, and 1.2 g of tetramethylammonium hydroxide in a reactor. The mixture is heated to 100° C. and maintained at this temperature for 30 minutes to establish an alkaline environment conducive to hydrolysis and condensation reactions.

Subsequently, a silane mixture including 25 g of 3-glycidoxypropyl trimethoxysilane, 25 g of heptadecafluorodecyl trimethoxysilane, and 45 g of PEG trimethoxysilane is added dropwise to the reactor at a controlled rate of 0.1 g per second. The addition is completed within 15 minutes, while the reaction pH is maintained in the range of 13-14 to ensure optimal conditions for hydrolysis and condensation. The reaction is allowed to proceed at 100° C. for 20 hours.

Upon completion of the reactions, the mixture is cooled to room temperature and subjected to centrifugation at 10,000 rpm for 20 minutes to separate the phases. Saturated saline water is added to perform a liquid-liquid extraction. The organic phase is collected and dried over magnesium sulfate to remove any residual moisture. The solvent in the dried organic solution is evaporated at 50° C. using a rotary evaporator, yielding a raw POSS product.

To further purify the raw POSS, a solvent mixture of ethyl acetate, isopropyl alcohol, and a fluorocarbon solvent is added to redissolve the crude material, followed by stirring for 1 hour. Hexane is then introduced to the solution to induce liquid-liquid extraction. After phase separation, the upper hexane layer containing the purified POSS product is collected and dried under reduced pressure.

The resulting purified POSS compound, identified as [(Glycidoxypropyl)₄(Heptadecafluorodecyl)₂(PEG)₂][SiO_{1.5}]₈, is a yellow liquid. This method demonstrates effective control over functional group incorporation and yields a highly pure, multifunctional POSS product suitable for advanced material applications.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A method of fabricating a multifunctional heteroleptic polyhedral oligomeric silsesquioxane (POSS) in a single reaction vessel, comprising:
adding a first organic solvent, water, base in a reaction vessel to create an alkaline environment for hydrolysis and condensation reactions;
introducing a set of organosilanes in a dropwise manner at a controlled rate to prevent rapid gelation, wherein the total organosilane content accounts for 15-50% of the total solution, wherein the controlled rate is between 0.1-0.5 g per second to ensure uniform cage formation;
subjecting the reaction vessel to a defined temperature and duration to initiate hydrolysis and condensation reactions, wherein the hydrolysis reaction converts alkoxy groups of the organosilanes to silanol groups, and the condensation reaction condenses the silanol groups to form siloxane bonds, resulting in POSS cage structures; and
adjusting the reaction mixture to a pH value of 3-5 by adding an acid to quench the condensation reaction, stabilizing the POSS cage structures, and prevent POSS aggregation, thereby yielding a POSS crude product;
wherein the set of organosilanes comprises glycidyltrimethoxysilane, cyclohexylepoxypropyltrimethoxysilane, methacryloxypropyltrimethoxysilane, acryloxypropyltrimethoxysilane, octyltrimethoxysilane, phenyltrimethoxysilane, aminopropyltrimethoxysilane, and polyethylene glycol (PEG)-modified silanes.

2. The method of claim 1, wherein the alkaline environment has a pH value ranging from 12 to 14.

3. The method of claim 1, wherein the defined temperate ranges from 25° C. to 150° C.

4. The method of claim 1, wherein the reaction duration ranges from 2 to 24 hours.

5. The method of claim 1, wherein the first organic solvent is selected from ethanol, acetone or a mixture thereof.

6. The method of claim 1, further comprising adding phase transfer catalysts to facilitate interactions between hydrophilic and hydrophobic components.

7. The method of claim 1, wherein the POSS crude product is further purified by:
removing the residual solvent and dissolving the crude POSS in a POSS-philic solvent;
using a siloxane gel-philic solvent to induce a liquid-liquid phase separation, thereby forming a siloxane gel phase and a POSS-philic solvent phase;
collecting, filtering, and evaporating the POSS-philic solvent phase to obtain a purified POSS product with a purity of over 98%.

8. The method of claim 7, wherein the POSS-philic solvent is selected from relatively polar organic solvents, such as acetone, butanone, acetonitrile, ethanol, or methanol.

9. The method of claim 7, wherein the siloxane gel-philic solvent is selected from toluene, n-hexane, or cyclohexane.

10. A multifunctional heteroleptic POSS produced by the method of claim 1.

11. The multifunctional heteroleptic POSS of claim 10, wherein the multifunctional heteroleptic POSS comprises two reactive and thermal stable groups: glycidyl-containing R¹ and cyclohexylepoxy-containing R², a photo/thermal-curable crosslinking group R³, a hydrophobic group R⁴, and a hydrophilic group R⁵.

12. The multifunctional heteroleptic POSS of claim 11, wherein the multifunctional heteroleptic POSS has a formula: [R¹ₘR²ₙR³ₒR⁴ₚR⁵_{q}][SiO₃/₂]_{m+n+o+p+q},
wherein the R¹ is selected from one of more of epoxypropoxy, epoxidized olefins, glycidyl, and glycidyl ether;
the R² is selected from one of more of epoxycyclohexane and cycloaliphatic epoxy;
the R³ is selected from one or more of the following: amine, oxetane, episulfide, acrylate, methacrylate, thiol-acrylate, thiol-methacrylate, acrylamide, vinyl sulfide, vinyl ether, styrene, norbornyl, cyclopentadiene, and acryloxypropyl;
the R⁴ is selected from alkyl chains, phenyl group, perfluoropolyether (PFPE), polytetrafluoroethylene (PTFE), and polydimethylsiloxane (PDMS);
the R⁵ is selected from alkyl chains, phenyl group, perfluoropolyether (PFPE), polytetrafluoroethylene (PTFE), and polydimethylsiloxane (PDMS); and
the m, n, o, p and q range from 0 to 20 with a sum equal or less than 20.

13. The multifunctional heteroleptic POSS of claim 10, wherein the multifunctional heteroleptic POSS is applied in advanced coatings, adhesives, biomedical materials, or nanocomposites.
